(19) United States
(12) Patent Application Publication
(10) Pub. No.: US 2009/0264268 A1
(43) Pub. Date: Oct. 22, 2009

(54) Method and arrangement for controlling the temperature of two cylinders

(76) Inventor: Hossain Peshkar, Malmo (SE)

Correspondence Address: BUCHANAN, INGERSOLL & ROONEY PC, POST OFFICE BOX 1404, ALEXANDRIA, VA, 22313-1404, US

(21) Appl. No.: 11/991,094

(22) PCT Filed: Dec. 8, 2006
(86) PCT No.: PCT/SE2006/001395

§ 371 Date: Feb. 27, 2008

(30) Foreign Application Priority Data
Jan. 31, 2006 (SE) 0600216-6

(51) Int. Cl. B31B 1/00

(52) U.S. Cl. 493/5

(57) ABSTRACT

Method and arrangement for controlling the temperature of two cylinders forming a nip. The temperature of at least one point on each cylinder is sensed by sensors, forming a point of measuring, wherein the highest sensed temperature is used as set point and wherein the cylinders are heated in areas where the sensed temperature is below the set point.

### TECHNICAL FIELD

The present invention concerns a system and a method of controlling and balancing the temperature of two cooperating cylinders forming a nip.

### PRIOR ART

In many circumstances where two cylinders form a nip it is most important that the distance between the cylinders are kept within a certain range. Often it is also important that cooperating parts of the cylinders are kept in line with each other.

For many types of cylinders such as scoring cylinders forming a nip it is important that they are properly aligned in relation to each other. In machines for forming containers from a web of a paper or laminate material, there are normally scoring cylinders at some stage. Scores are formed in the web, to assist in the folding of the packages. One of the scoring cylinders has projections that are to go into interacting grooves of the other cylinder. Not properly aligned scoring cylinders may lead to cuts in the web to be scored. When cylinders are heated they will expand. If scoring cylinders are unevenly heated they will expand unevenly which may lead to that cooperating parts of the cylinders does not align properly. Thus, the projection of one cylinder may hit the sides of the grooves of the other cylinder, which probably will cut the web.

### SUMMARY OF THE INVENTION

In view of the above one object of the present invention is to eliminate or at least reduce the risk of cutting of a web at a scoring unit due to uneven heating.

One aspect of the present invention is to control the temperature of the two cylinders forming the nip. According to the invention the temperature of the cylinders including bearings and drive are measured continuously in a number of separate points. The algorithm for the temperature control is based on the highest registered temperature, which temperature will form the set point. The other parts of the cylinders, bearings and drive are then heated to the registered highest temperature, i.e. the set point.

In another aspect of the present invention the temperature at different parts of the cylinders, bearings and drive are still registered. Heaters ate still provided for heating of the different parts of the cylinders. However, according to this aspect of the present invention the cylinders are placed displaceable at the ends in relation to each other. Either only one or both cylinders are displaceable. The cylinder or cylinders are displaced based on the sensed temperatures.

By means of the present invention the temperature of the cylinders are evenly distributed. Without a control system such as according to the present invention there may be a relatively large difference between the highest and the lowest temperature of the cylinders of the nip.

Even tough the present invention is normally described in connection with scoring cylinders at machines for forming containers, a person skilled in the art realises that the principles of the present invention may be used for other cylinders forming a nip.

The control cycle of the present invention is developed for webs having a thickness of at least 150 μm.

### BRIEF DESCRIPTION OF THE DRAWINGS

The invention will be described further below by way of examples and with reference to the enclosed Figs. In the Figs.,

FIG. 1 is a schematic side view of two scoring cylinders incorporating the present invention,

FIG. 2 is a detailed view of a part of a nip of the scoring cylinders of FIG. 1,

FIG. 3 is one example of a heater assembly that may be used with the present invention, and

FIG. 4 is a schematic end view of one of the cylinders of FIG. 1.

### DETAILED DESCRIPTION OF PREFERRED EMBODIMENTS

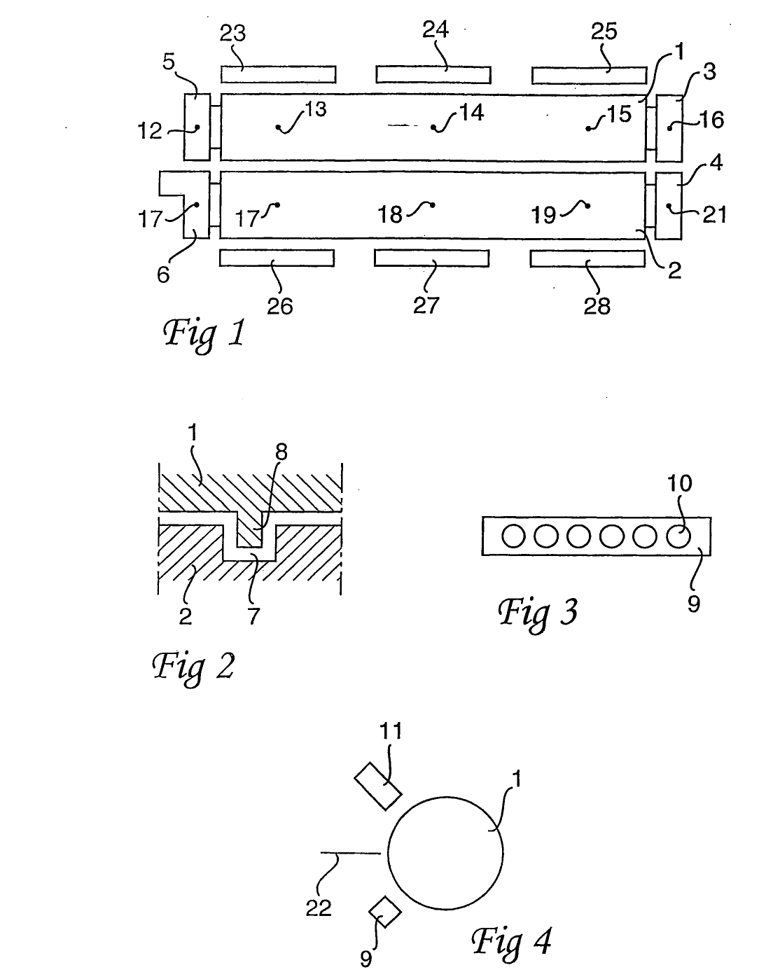

In FIG. 1 two scoring cylinders 1, 2 are shown, as one example. Each end of the cylinders 1, 2 is received in a bearing housing 3, 4, 5, 6. One of the bearing housings 6 includes a drive unit.

One of the scoring cylinders 1 has projections 8 formed on the surface of the cylinder 1. The projections 8 are to be received in grooves 7 of the other scoring cylinder 2. If the cylinders 1, 2 are unevenly heated they will expand in various degrees. If the projection 8 of one scoring cylinder 1 due to such uneven heating gets too close to the groove 7 of the other cylinder 2, the web to be scored may be cut in the contact between projection 8 and groove 7.

Heaters 23-28 are arranged along each cylinder 1, 2. Normally at least three heaters 23-28 are arranged for each cylinder 1, 2, one at each end and one in the middle. A person skilled in the art realises that the exact number of heaters are decided in each case depending on the dimensions of the cylinders, the demands on sensitivity etc. In FIG. 3 one example of a heater is shown as a ramp 9 having a number of IR-carbon light heaters 10. In this embodiment heaters may be placed also inside the bearing housings 3-6, which heaters may be air heaters. In other embodiments there are no heaters in the bearing housings 3-6 as the drive unit and bearings normally generates much of the heat during use. The bearing housings 3-6 include oil that assists in distributing the generated heat inside the bearing housings 3-6.

A sensor 11 is associated with at least each heater 23-28 but further sensors may be arranged. The sensors 11 measure the temperature at specific points 12-21 on the cylinders or parts associated with the cylinders. The sensors 11 are normally IR-sensors, but any suitable type of sensor may be used.

In use one IR-sensor 11 is directed against points of measuring 13-15, 17-19 on the cylinders 1, 2. The IR-sensors measure without contact. In the bearing housings 3-6 other types of temperature gauges may be used, such as a strain gauge. In each bearing housing 3-6 a point of measuring 12, 16, 20, 21 is established. The points of measuring 13-21 are indicated in FIG. 1. In the example shown in FIG. 1 there are six heater assemblies 23-28, one at each end and one in the middle of each cylinder 1, 2. The six heaters 23-28 are associated with one point of measuring 13-15, 17-19 each. A person skilled in the art realises that many different types of sensors and heater assemblies may be used.

To reduce the risk of the heaters 23-28 influencing the sensors 11, one or several shields 22 may be placed between the heaters and the sensors along each cylinder 1, 2, as indicated in FIG. 4. The shields 22 will extend directed away from the cylinders 1, 2.

The control system of the present invention is based on the highest sensed temperature. Said highest sensed temperature will be used as set point for the other points of measuring 12-21. Thus, if the sensed temperature of a specific measuring point is below the hottest sensed measuring point, the heater associated with that measuring point is activated. If the difference to the highest sensed temperature is above a predetermined value, the associated heater will be run at full effect. When the difference is below said predetermined value the heater will be run at less than 100% and will normally be controlled in such a way that the temperature of the specific measuring point will approach the established set point without exceeding it.

As long as the temperatures of the points of measuring 12-21 are within a certain interval the cylinders 1, 2 will expand relatively evenly, which means that the risk of cutting of the web to be scored is reduced dramatically. A person skilled in the art realises that the temperature interval and the maximal allowed temperature difference between specific points of measuring 12-21 will depend on a number of factors, such as the dimensions of the cylinders 1, 2, the dimensions of the cooperating projections 8 and groove 7 in the forming of the scores, the quality and material of the web, the speed of the web.

In one example the heaters 23-28 are run at full effect if the sensed difference between a specific point of measuring 12-21 and the set point exceeds 2° C. When the difference is below 2° C. the specific heater 23-28 is controlled to let the temperature approach the set temperature without exceeding it. If the temperature in one specific point exceeds the set temperature, that higher temperature will be the new set temperature, if it still exceeds the former set temperature after a predetermined time interval. In one example this time interval was set to 8 minutes.

In one other embodiment the distances between the ends of the cylinders 1, 2 may be altered. This is done in that either only one of the cylinders 1, 2 or both cylinders 1, 2 are arranged moveable, in relation to each other in such a way that there mutual distance is varied. Normally only one of the cylinders 1, 2 is arranged moveable. In this embodiment there are no heaters in the bearing housings 3-6, but there are heaters along the cylinders 1, 2 in the same way as described above. Also in this embodiment the highest sensed temperature is the set temperature for the rest of the points of measuring 12-21.

The sensors 11, heaters 23-28 and possible actuators to move one or both cylinders 1, 2 are connected to a controller, such as a computer or a CPU. The controller will hold the algorithm by which the heaters 23-28 and possible actuators are controlled, based on the temperatures sensed by the sensors 11.

In some embodiments fans, vortex tubes or other cooling means are placed together with the heaters 23-28, in which case the temperature control may be done by a combination of heating and cooling or only by cooling. Often the cooling means are only placed at end shafts of the cylinders 1, 2.

The temperature range and the time interval are determined based on the dimensions of the cylinders 1, 2 and the scoring parts 7, 8 of the cylinders 1, 2, on the expected temperature of the cylinders 1, 2 and on the quality and dimensions of the web to be scored.
1. cylinder (scoring cylinder)
2. cylinder (scoring cylinder)
3. bearing housing
4. bearing housing
5. bearing housing
6. bearing housing, drive
7. groove
8. projection
9. ramp
10. IR-carbon light heater
11. IR-sensor
12. point of measuring
13. point of measuring
14. point of measuring
15. point of measuring
16. point of measuring
17. point of measuring
18. point of measuring
19. point of measuring
20. point of measuring
21. point of measuring
22. shield
23. heater
24. heater
25. heater
26. heater
27. heater
28. heater

1. A method of controlling the temperature of two cylinders forming a nip, comprising: sensing the temperature of at least one point on each cylinder, forming a point of measuring, using a highest sensed temperature as a set point, and heating the cylinders in areas where the sensed temperature is below the set point.

2. The method of claim 1, wherein the temperature is sensed at least at three points of each cylinder of the nip, two points at respective ends of the cylinder and one point in a middle of the cylinder and wherein the temperatures are sensed continuously.

3. The method of claim 1, wherein a heater is associated with each point of measuring and wherein the heater associated with a specific point is run at full effect if the difference between the sensed temperature at that specific point and the set point for the temperature is outside a predetermined range.

4. The method of claim 3, wherein if the difference of the sensed temperature and the set point for the temperature is within the predetermined range the heater is run in such a way that the temperature at the specific point is approaching but not exceeding the set point.

5. The method of claim 1, wherein the set point is amended if a higher temperature is sensed at a specific point for a predetermined time interval, in which case said higher temperature is established as a new set point.

6. The method of claim 4, wherein said predetermined temperature range is 1-4° C. and said predetermined time interval is 4-12 minutes.

7. The method of claim 6, further comprising changing a position of at least one of the at least two cylinders in relation to the other cylinder depending on the set point for the temperatures and the sensed temperatures.

8. The method of claim 7, wherein an algorithm for control is placed in a controller connected with the sensors, heaters and means to alter the position, which algorithm contains the actual predetermined temperature range and time interval.

9. The method of claim 6, wherein the two cylinders are scoring cylinders used in a scoring unit of a machine for forming containers from a web of a paper or laminated material and wherein the temperature range and the time interval are determined based on dimensions of the cylinders and scoring parts of the cylinders, on an expected temperature of the cylinders and on quality and dimensions of the web to be scored.

10. The method of claim 1, further comprising cooling parts of the cylinders of the nip and/or bearing housings associated with the cylinders.

11. An arrangement for controlling a temperature of two cylinders forming a nip, comprising two cylinders positioned relative to one another to form a nip, sensors to measure the temperature at specific points of measuring on the cylinders or parts associated with the cylinders.

12. The arrangement of claim 11, wherein a heater is associated with each point of measuring on the cylinders and placed in order to heat an area around the point of measuring.

13. The arrangement of claim 12, wherein the sensors are IR-sensors and wherein the heaters are formed as ramps receiving a number of IR-carbon light heaters.

14. The arrangement of claim 12, wherein temperature sensors are placed in bearing housings of the cylinders and wherein air heaters are placed in the bearing housings.

15. The arrangement of claim 11, wherein means are arranged to alter the position of at least one cylinder of the nip in relation to the other cylinder.

16. The arrangement of claim 15, wherein the sensors, the heaters and the means of altering the position of at least one cylinder are connected to a controller and wherein the controller is a computer or CPU containing a control algorithm.

17. The arrangement of claim 11, wherein cooling means in the form of fans or vortex tubes are arranged at end shafts of the cylinders.

18. The arrangement of claim 13, wherein a shield is placed between each sensor and the associated heater, which shield extends radially from the cylinder.

19. The method of claim 5, wherein said predetermined temperature range is about 2° C. and said predetermined time interval is about 8 minutes.

20. A method of controlling temperatures of first and second scoring cylinders which are positioned relative to one another to define a nip between which a web passes to be scored by the scoring cylinders, the method comprising:
sensing temperature at a plurality of points on the first scoring cylinder to determine sensed temperature at each of the points on the first scoring cylinder;
sensing temperature at a plurality of points on the second scoring cylinder to determine sensed temperature at each of the points on the second scoring cylinder;
identifying a highest one of the sensed temperatures as a set point temperature; and
heating areas of the first and second scoring cylinders where the sensed temperature is below the set point temperature.
